(19) United States
(12) Patent Application Publication
(10) Pub. No.: US 2025/0216112 A1
(43) Pub. Date: Jul. 3, 2025

(54) CONTROL METHOD FOR AIR OUTLET APPARATUS AND AIR OUTLET APPARATUS

(71) Applicant: GD MIDEA ENVIRONMENT APPLIANCES MFG CO., LTD., Zhongshan (CN)

(72) Inventors: Runfa WANG, Zhongshan (CN); Yongxin YE, Zhongshan (CN); Biao WANG, Zhongshan (CN); Xinsheng GUO, Zhongshan (CN); Dingshan ZOU, Zhongshan (CN); Zhuangyao ZHANG, Zhongshan (CN); Lianjie HUANG, Zhongshan (CN); Dongcheng MENG, Zhongshan (CN); Fuxiong XIE, Zhongshan (CN); Rui WANG, Zhongshan (CN); Sijin YE, Zhongshan (CN)

(21) Appl. No.: 19/002,421

(22) Filed: Dec. 26, 2024

(30) Foreign Application Priority Data
Dec. 29, 2023 (CN) 202311867840.3

(51) Int. Cl. F24F 11/79

(52) U.S. Cl. CPC F24F 11/79

(57) ABSTRACT

A control method includes determining, in response to receiving an air outlet angle customization instruction, two positions selected by a user within a swing range of a swing mechanism of an air outlet apparatus as a starting position and an ending position, and controlling the swing mechanism to swing between the starting position and the ending position.

### CROSS-REFERENCE TO RELATED APPLICATION

This application claims priority to Chinese Application No. 202311867840.3, filed on Dec. 29, 2023, the entire content of which is incorporated herein by reference.

### FIELD

The present disclosure relates to the field of air outlet apparatus technologies, and more particularly, to a control method for an air outlet apparatus and an air outlet apparatus.

### BACKGROUND

Swing function of a fan is a basic function commonly used by users, and selection of multiple swing angles is also a common function of fans. Conventional fans generally have fixed swing angles such as 60 degrees and 90 degrees. During use, when a small swing angle is selected, a swing range may be insufficient. However, selecting a larger swing angle may result in a longer waiting time for the user. In addition, a limited number of available angle options makes it difficult to customize a swing range for the users as desired.

### SUMMARY

A main object of the present disclosure is to provide a control method for an air outlet apparatus and an air outlet apparatus, aiming at solving the problem in the conventional air outlet apparatus that fewer angles can be selected by users, which makes it difficult to customize a swing range for the user as desired.

To achieve the above object, a control method for an air outlet apparatus is provided according to the present disclosure. The air outlet apparatus includes a swing mechanism configured to control an air outlet direction. The control method includes: determining, during an operation of the air outlet apparatus and swinging of the swing mechanism, two positions selected by a user within a swing range of the swing mechanism as a starting position and an ending position subsequent to receiving an air outlet angle customization instruction; and controlling the swing mechanism to swing between the starting position and the ending position.

In another exemplary embodiment of the present disclosure, the determining, during the operation of the air outlet apparatus and the swinging of the swing mechanism, the two positions selected by the user within the swing range of the swing mechanism as the starting position and the ending position subsequent to receiving the air outlet angle customization instruction includes: controlling, in response to receiving the air outlet angle customization instruction, the swing mechanism to operate when the air outlet apparatus is operating and the swing mechanism is in a stopped state; and determining two positions selected by the user within the swing range of the swing mechanism as the starting position and the ending position during the swinging of the swing mechanism.

In another exemplary embodiment of the present disclosure, the controlling, in response to receiving the air outlet angle customization instruction, the swing mechanism to operate when the air outlet apparatus is operating and the swing mechanism is in the stopped state includes: controlling, in response to receiving the air outlet angle customization instruction, the swing mechanism to swing within a maximum allowable range when the swing mechanism is in the stopped state.

In another exemplary embodiment of the present disclosure, the controlling, in response to receiving the air outlet angle customization instruction, the swing mechanism to operate when the air outlet apparatus is operating and the swing mechanism is in the stopped state includes: controlling, in response to receiving the air outlet angle customization instruction, the swing mechanism to swing within a predetermined swing range when the swing mechanism is in the stopped state. The predetermined swing range is symmetrical with respect to a center of a maximum allowable swing range of the swing mechanism.

In another exemplary embodiment of the present disclosure, the controlling, in response to receiving the air outlet angle customization instruction, the swing mechanism to operate when the air outlet apparatus is operating and the swing mechanism is in the stopped state includes: matching, in response to receiving the air outlet angle customization instruction, a historical swing range corresponding to the air outlet angle customization instruction based on the air outlet angle customization instruction when the swing mechanism is in the stopped state; and controlling the swing mechanism to swing within the historical swing range.

In another exemplary embodiment of the present disclosure, the determining, during the operation of the air outlet apparatus and the swinging of the swing mechanism, the two positions selected by the user within the swing range of the swing mechanism as the starting position and the ending position subsequent to receiving the air outlet angle customization instruction includes: during the operation of the air outlet apparatus and the swinging of the swing mechanism, in response to receiving one position selected by the user within the swing range of the swing mechanism, when a further position selected by the user within the swing range of the swing mechanism is received within a predetermined period of time, determining the one position and the further position as the starting position and the ending position.

In another exemplary embodiment of the present disclosure, the control method further includes, subsequent to the controlling the swing mechanism to swing between the starting position and the ending position: controlling, in response to receiving the air outlet angle customization instruction again, the swing mechanism to swing in a current swing range; determining two new positions selected by the user within the swing range of the swing mechanism as a new starting position and a new ending position during the swinging of the swing mechanism; and controlling the swing mechanism to swing between the new starting position and the new ending position.

In another exemplary embodiment of the present disclosure, the determining, during the operation of the air outlet apparatus and the swinging of the swing mechanism, the two positions selected by the user within the swing range of the swing mechanism as the starting position and the ending position subsequent to receiving the air outlet angle customization instruction includes: during the operation of the air outlet apparatus and the swinging of the swing mechanism, determining, in response to receiving the air outlet angle customization instruction, a received position of resistance opposite to a swing direction as a first position, and controlling the swing mechanism to change the swing direction; and determining a re-received position of resistance opposite to the swing direction as a second position, controlling the swing mechanism to change the swing direction, and determining the first position and the second position as the starting position and the ending position.

An air outlet apparatus is further provided according to the present disclosure. The air outlet apparatus includes a body including a blower and a swing mechanism, an operation device, and a control device. The swing mechanism is configured to control an air outlet direction of the blower. The operation device is arranged at the body, and is configured to receive an air outlet angle customization instruction. The control device is electrically connected to the swing mechanism and the operation device. The control device includes a memory, a processor, and a control program for the air outlet apparatus stored on the memory and executable on the processor. The control program for the air outlet apparatus is configured to implement the steps of the above control method.

In another exemplary embodiment of the present disclosure, the air outlet apparatus includes a fan, an air conditioner, or a heater.

In the technical solution of the present disclosure, the air outlet apparatus includes the swing mechanism. The swing mechanism is mainly configured to adjust the air outlet direction of the air outlet apparatus. Specific configuration of the swing mechanism is not limited, which may drive the blower of the air outlet apparatus to swing to adjust the air outlet direction of the blower and thus adjust the air outlet direction of the air outlet apparatus. In another embodiment, the specific configuration of the swing mechanism may drive an air deflector at an air outlet of the air outlet apparatus to swing to adjust a direction in which the air deflector guides an airflow, and thus to adjust the air outlet direction of the air outlet apparatus. The swing mechanism is configured in such a way to adjust the air outlet direction of the air outlet apparatus. The present disclosure provides a control method on the basis that the swing mechanism is provided to adjust the air outlet direction of the air outlet apparatus. In an exemplary embodiment of the present disclosure, when the air outlet apparatus is operating and the swing mechanism is swinging, the user can send an air outlet angle customization instruction to the air outlet apparatus by a hand-held controller or through a control panel of the air outlet apparatus. The air outlet apparatus enters a customized air outlet angle setting state. In this case, as the swing mechanism operates within the current swing range, the user can select two positions sequentially within the current swing range during the swinging process of the swing mechanism to determine the starting position and the ending position. A region between the starting position and the ending position becomes a new swing range for the swing mechanism, which may swing between the starting position and the ending position. For example, when the air outlet apparatus enters the customized air outlet angle setting state, as the swing mechanism swings, when the swing mechanism swings to the first position, the user selects the first position as the starting position. Then, the swing mechanism continues to operate within the current swing range. When the swing mechanism swings to the second position, the user selects the second position as the ending position. In this case, the swing mechanism immediately changes the swing direction to swing between the first position and the second position. A region between the first position and the second position is determined as the new swing range for the swing mechanism. In this way, the user can directly send the air outlet angle customization instruction to the air outlet apparatus by the hand-held controller or on the control panel of the air outlet apparatus, and select an air outlet angle of the air outlet apparatus as desired, expanding an application range of the air outlet apparatus and improving user experience.

### BRIEF DESCRIPTION OF THE DRAWINGS

To more clearly illustrate embodiments of the present disclosure, accompanying drawings used in the description of the embodiments are briefly described below. Obviously, the accompanying drawings in the following descriptions are only some embodiments of the present disclosure. For those skilled in the art, other accompanying drawings can be obtained from structures illustrated in these accompanying drawings without creative work.

FIG. 1 is a schematic flowchart illustrating a control method for an air outlet apparatus according to a first embodiment of the present disclosure.

FIG. 2 is a schematic flowchart illustrating a control method for an air outlet apparatus according to a second embodiment of the present disclosure.

FIG. 3 is a schematic flowchart illustrating a control method for an air outlet apparatus according to a third embodiment of the present disclosure.

FIG. 4 is a schematic flowchart illustrating a control method for an air outlet apparatus according to a fourth embodiment of the present disclosure.

FIG. 5 is a schematic flowchart illustrating a control method for an air outlet apparatus according to a fifth embodiment of the present disclosure.

FIG. 6 is a schematic flowchart illustrating a control method for an air outlet apparatus according to a sixth embodiment of the present disclosure.

FIG. 7 is a schematic flowchart illustrating a control method for an air outlet apparatus according to a seventh embodiment of the present disclosure.

FIG. 8 is a schematic flowchart illustrating a control method for an air outlet apparatus according to an eighth embodiment of the present disclosure.

FIG. 9 is a schematic structural view of a control device in a hardware operating environment involved in the embodiment illustrated in FIG. 1.

Description of reference numerals of the accompanying drawings:

| Reference | |
|---|---|
| numerals | Term |
| 1001 | Processor |
| 1002 | Communication bus |
| 1003 | User interface |
| 1004 | Information interface |
| 1005 | Memory |

Implementations of the objects, functional features, and advantages of the present disclosure will be further described in conjunction with the embodiments and with reference to the accompanying drawings.

### DETAILED DESCRIPTION OF THE EMBODIMENTS

Technical solutions according to embodiments of the present disclosure will be described below in combination with accompanying drawings of the embodiments of the present disclosure. Obviously, the embodiments described below are only part of the embodiments of the present disclosure, rather than all embodiments of the present disclosure. On a basis of the embodiments of the present disclosure, all other embodiments obtained by those skilled in the art without creative work shall fall within the scope of the present disclosure.

It should be noted that all directional indications, such as up, down, left, right, front, and rear, in the embodiments of the present disclosure are only used to explain relative positions between various components, movements of various components, or the like under a predetermined posture (as illustrated in the figures). When the predetermined posture changes, the directional indications also change accordingly.

In addition, descriptions, such as “first” and “second,” in the present disclosure are only used for descriptive purposes, and cannot be understood as indicating or implying relative importance or implicitly indicating the number of indicated technical features. Therefore, the features associated with “first” and “second” may explicitly or implicitly include at least one of the features. In addition, the term “and/or” used throughout the whole context refers to three possible schemes. Taking “A and/or B” as an example, the three possible schemes include a scheme of A alone, a scheme of B alone, or a scheme where both A and B are satisfied simultaneously. In addition, the technical solutions may be combined according to various embodiments of the present disclosure, but these combinations must be based on the fact that they can be realized by those skilled in the art. When a combination of the technical solutions is contradictory or unattainable, the combination of the technical solutions neither exists nor falls within the scope of the present disclosure.

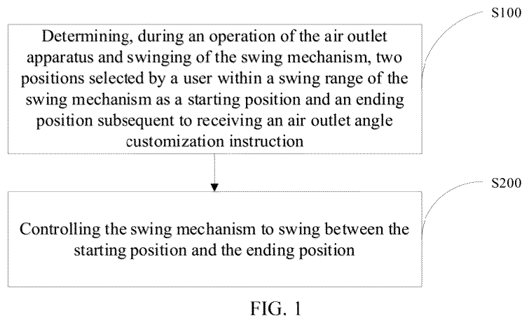

A control method for an air outlet apparatus is provided according to the present disclosure. FIGS. 1 to 8 show specific embodiments of the control method for the air outlet apparatus provided by the present disclosure. The control method for the air outlet apparatus is described below with reference to specific drawings.

As illustrated in FIG. 1, the air outlet apparatus includes a swing mechanism configured to control an air outlet direction. The control method for the air outlet apparatus includes operations at blocks.

At block S100, during an operation of the air outlet apparatus and swinging of the swing mechanism, two positions selected by a user within a swing range of the swing mechanism are determined as a starting position and an ending position subsequent to receiving an air outlet angle customization instruction.

During the swinging of the swing mechanism within the swing range, the user may successively select two mutually spaced positions within a current swing range. The two mutually spaced positions are determined as the starting position and the ending position within a new swing range of the swing mechanism.

At block S200, the swing mechanism is controlled to swing between the starting position and the ending position.

It should be understood that a range between the starting position and the ending position is the new swing range of the swing mechanism. After the new swing range of the swing mechanism is determined, the current swing range of the swing mechanism is adjusted to the new swing range.

In the technical solution of the present disclosure, the air outlet apparatus is provided with the swing mechanism. The swing mechanism is mainly configured to adjust the air outlet direction of the air outlet apparatus. Specific configuration of the swing mechanism is not limited, which may drive a blower of the air outlet apparatus to swing to adjust an air outlet direction of the blower and thus adjust an air outlet direction of the air outlet apparatus. In another embodiment, the specific configuration of the swing mechanism may drive an air deflector at an air outlet of the air outlet apparatus to swing to adjust a direction in which the air deflector guides an airflow, and thus to adjust the air outlet direction of the air outlet apparatus. The swing mechanism is specifically configured in such a way as to adjust the air outlet direction of the air outlet apparatus. The present disclosure provides a control method on the basis that the swing mechanism is provided to adjust the air outlet direction of the air outlet apparatus. In an exemplary embodiment of the present disclosure, when the air outlet apparatus is operating and the swing mechanism is swinging, the user can send the air outlet angle customization instruction to the air outlet apparatus by a hand-held controller or on a control panel of the air outlet apparatus. The air outlet apparatus enters a customized air outlet angle setting state. In this case, as the swing mechanism operates within the current swing range, the user selects two positions sequentially within the current swing range of the swing mechanism during the swinging of the swing mechanism to determine the starting position and the ending position. A region between the starting position and the ending position becomes a new swing range for the swing mechanism, which may swing between the starting position and the ending position. For example, when the air outlet apparatus enters the customized air outlet angle setting state, as the swing mechanism swings, the user selects a first position as the starting position when the swing mechanism swings to the first position. Then, the swing mechanism continues to operate within the current swing range. When the swing mechanism swings to a second position, the user selects the second position as the ending position. In this case, the swing mechanism immediately changes the swing direction to swing between the first position and the second position. A region between the first position and the second position is determined as the new swing range for the swing mechanism. In this way, the user can directly send the air outlet angle customization instruction to the air outlet apparatus by the hand-held controller or on the control panel of the air outlet apparatus, and select an air outlet angle of the air outlet apparatus as desired, expanding an application range of the air outlet apparatus and improving user experience.

It should be noted that, to further facilitate the user to observe whether the air outlet apparatus has entered the customized air outlet angle setting state. In embodiments of the present disclosure, the air outlet apparatus further includes an indicator light configured to display different colors. When the air outlet apparatus operates normally and the swing mechanism swings, the indicator light displays one color. Once the user sends the air outlet angle customization instruction to the air outlet apparatus, causing the air outlet apparatus to enter the customized air outlet angle setting state, the color of the indicator light changes to notify the user that the air outlet apparatus is in the customized air outlet angle setting state. After the user selects two positions sequentially within the current swing range of the swing mechanism as the starting position and the ending position, and the swing mechanism swings between the starting position and the ending position, the indicator light reverts to a previous color, which indicates to the user that customized air outlet angle setting is completed, and the air outlet apparatus resumes normal operation.

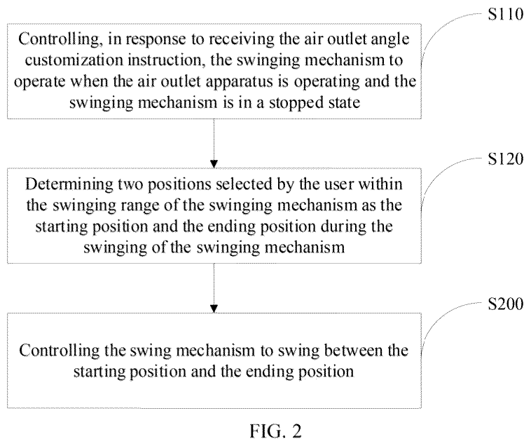

Further, as illustrated in FIG. 2, in a second embodiment of the present disclosure, the operation at block S100 includes operations at blocks below.

At block S110, when the air outlet apparatus is operating and the swing mechanism is in a stopped state, the swing mechanism is controlled to operate in response to receiving the air outlet angle customization instruction.

It should be understood that when the air outlet apparatus is operating normally and the swing mechanism is not in operation and is in the stopped state, the user sends the air outlet angle customization instruction to the air outlet apparatus. After the air outlet apparatus receives the air outlet angle customization instruction sent by the user, the air outlet apparatus can automatically start the swing mechanism to cause the swing mechanism to start swinging.

At block S120, two positions selected by the user within the swing range of the swing mechanism are determined as the starting position and the ending position during the swinging of the swing mechanism.

After the air outlet apparatus receives the air outlet angle customization instruction sent by the user, the air outlet apparatus starts the swing mechanism to swing. The air outlet apparatus can automatically enter the customized air outlet angle setting state to enable the user to select the starting position and the ending position within the current swing range of the swing mechanism, and further to enable the air outlet apparatus to perform air outlet operation between the starting position and the ending position.

During use of the air outlet apparatus, the air outlet angle customization instruction is typically obtained through user operations. However, when the air outlet apparatus is operating normally and the swing mechanism is not operating and is in the stopped state, the user may need to start the swing mechanism before setting the customized air outlet angle and the air outlet apparatus can obtain the air outlet angle customization instruction, which may be inconvenient. Therefore, in this embodiment, a method is provided for initiating the swing mechanism when the swing mechanism is in the stopped state. When the air outlet apparatus is operating but the swing mechanism does not operate, if the air outlet apparatus receives the air outlet angle customization instruction, the swing mechanism is initiated and the air outlet apparatus is controlled to enter the customized air outlet angle setting state. In this case, during the swinging of the swing mechanism, the user can still select two positions sequentially within the current swing range of the swing mechanism as the starting position and the ending position. A region between the starting position and the ending position becomes a new swing range for the swing mechanism, achieving a purpose of customizing an air outlet range of the air outlet apparatus. Thus, the user does not need to perform additional operations such as starting the swing mechanism, reducing complexity of user operations.

In other embodiments of the present disclosure, when the air outlet apparatus automatically starts the swing mechanism to cause the swing mechanism to swing after receiving the air outlet angle customization instruction issued by the user, a swing range of the swing mechanism may be selected to be multiple types.

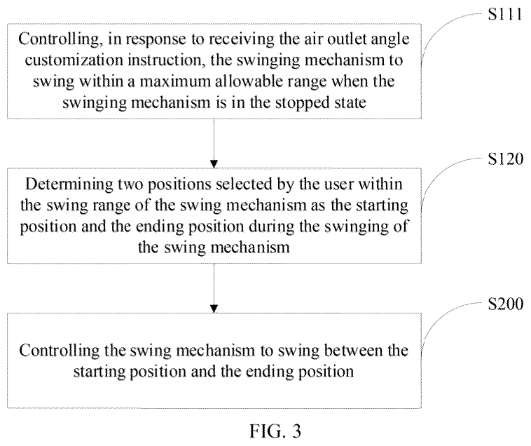

As illustrated in FIG. 3, in a third embodiment of the present disclosure, the operation at block S110 includes operations at blocks below.

At block S111, when the swing mechanism is in the stopped state, the swing mechanism is controlled to swing within a maximum allowable range in response to receiving the air outlet angle customization instruction.

In the previous embodiment, it is described that the air outlet apparatus can start the swing mechanism to cause the swing mechanism to swing after receiving the air outlet angle customization instruction issued by the user. Therefore, in this embodiment, the swing range for the swing mechanism is provided after the swing mechanism is initiated. That is, when the air outlet apparatus is operating normally and the swing mechanism is not in operation and is in the stopped state, the user sends the air outlet angle customization instruction to the air outlet apparatus. After the air outlet apparatus receives the air outlet angle customization instruction sent by the user, the air outlet apparatus can start the swing mechanism. Furthermore, there are no limits on a swing angle of the swing mechanism. Instead, the maximum allowable swing range of the swing mechanism is set as the current swing range of the swing mechanism to allow the swing mechanism to operate within the maximum allowable range. In this case, the air outlet apparatus enters the customized air outlet angle setting state. When the swing mechanism swings within the maximum allowable swing range, the user can select two mutually spaced positions sequentially as the starting position and ending position. Therefore, the swing range of the swing mechanism can be changed, allowing the air outlet apparatus to perform the air outlet operation within a customized air outlet range. Such a configuration enables the user to select the starting position and the ending position within the maximum swing range of the swing mechanism, sufficiently satisfying requirements of the user, and preventing the user from being unable to select a desired customized air outlet range.

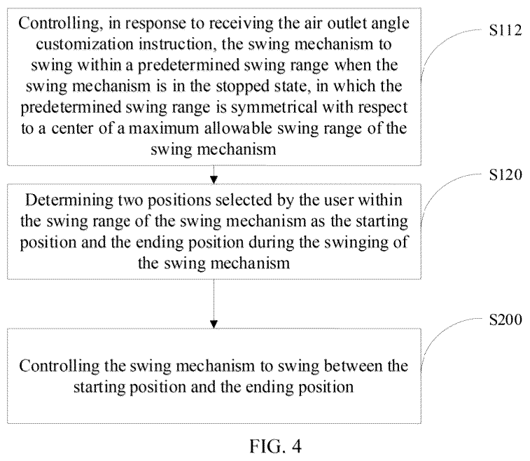

In addition, the swing range of the swing mechanism may be selected as another range. As illustrated in FIG. 4, in a fourth embodiment of the present disclosure, the operation at block S110 includes operations at blocks below.

At block S112, when the swing mechanism is in the stopped state, the swing mechanism is controlled to swing within a predetermined swing range in response to receiving the air outlet angle customization instruction. The predetermined swing range is symmetrical with respect to a center of a maximum allowable swing range of the swing mechanism.

In the previous embodiment, after the swing mechanism is initiated, the maximum allowable swing range of the swing mechanism is the current swing range to ensure that the user can select the starting position and the ending position within the maximum swing range of the swing mechanism, fully meeting requirements of the user. However, there are scenarios where the user does not need to select the starting position and the ending position within the maximum swing range of the swing mechanism. Therefore, in this embodiment, another swing range of the swing mechanism is provided after the swing mechanism automatically starts. That is, when the air outlet apparatus is operating normally and the swing mechanism is not in operation and is in the stopped state, the user sends the air outlet angle customization instruction to the air outlet apparatus. After the air outlet apparatus receives the air outlet angle customization instruction sent by the user, the air outlet apparatus starts the swing mechanism. Moreover, the swing mechanism is controlled to swing within the predetermined swing range. It should be understood that the predetermined swing range is smaller than the maximum allowable swing range. A time required for the swing mechanism to swing from the starting position to the ending position within the predetermined swing range is smaller than a time required for the swing mechanism to swing from the starting position to the ending position within the maximum allowable swing range. In this case, the air outlet apparatus also enters the customized air outlet angle setting state. When the swing mechanism swings within the predetermined swing range, the user can sequentially select two mutually spaced positions as the starting and the ending position, changing the swing range of the swing mechanism, and thus allowing the air outlet apparatus to perform the air outlet operation within the customized air outlet range. Therefore, the user does not need to select two positions having a sufficiently large spacing between the two positions as the starting position and the ending position. When the swing mechanism swings within the predetermined swing range, a waiting time of the user for selecting the two positions can be saved, which allows the user to more quickly determine the customized air outlet range, making operation more convenient and further meeting the user requirements.

It should be noted that when the swing mechanism is initiated, if the swing mechanism is not within the predetermined swing range, the swing mechanism swings to the starting position or the ending position of the predetermined swing range, and then swings within the predetermined swing range.

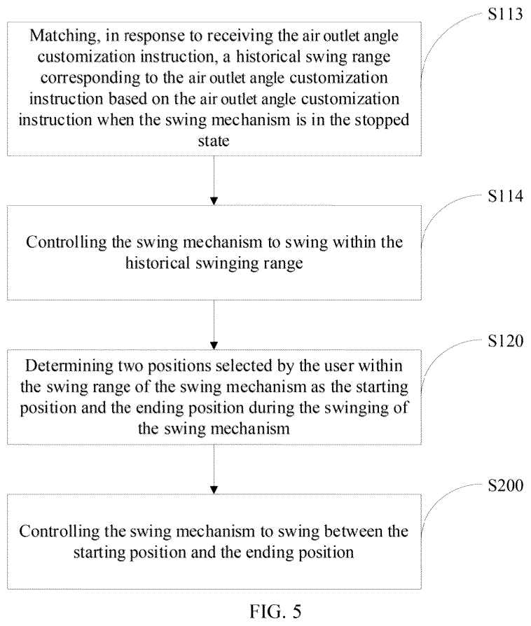

Further, in the above two embodiments, after the swing mechanism starts, the user still needs to continue to select the starting position and the ending position within the current swing range of the swing mechanism, to achieve the purpose of causing the air outlet apparatus to perform the air outlet operation based on the customized air outlet angle. As illustrated in FIG. 5, when the user needs to directly cause the air outlet apparatus to perform the air outlet operation based on the customized air outlet angle after the swing mechanism starts. In a fifth embodiment of the present disclosure, the operation at block S110 includes operations at blocks below.

At block S113, when the swing mechanism is in the stopped state, in response to receiving the air outlet angle customization instruction, a historical swing range corresponding to the air outlet angle customization instruction is matched based on the air outlet angle customization instruction.

It should be understood that the historical swing range is a range between the starting position and the ending position when the swing mechanism last swung within the customized air outlet angle. Thus, after the air outlet apparatus receives the customized outlet angle instruction issued by the user, the swing mechanism is initiated, and the air outlet apparatus can automatically obtain the starting position and the ending position selected by the user during the last air outlet operation of the air outlet apparatus based on the customized air outlet angle, and select the starting position and the ending position as a current starting position and a current ending position. In this way, the current swing range of the swing mechanism matches the historical swing range of the swing mechanism. That is, a historical swing range is obtained and the current swing range is set to the historical swing range.

At block S114, the swing mechanism is controlled to swing within the historical swing range.

The swing mechanism is controlled to swing between the current starting position and the current ending position.

In this embodiment, when the air outlet apparatus is operating normally and the swing mechanism is not in operation and is in the stopped state, the user sends the air outlet angle customization instruction to the air outlet apparatus. After the air outlet apparatus receives the air outlet angle customization instruction sent by the user, the air outlet apparatus can start the swing mechanism. Furthermore, the air outlet apparatus obtains the starting position and the ending position selected by the user during the last air outlet operation where the air outlet apparatus performs the air outlet operation based on the customized air outlet angle, and selects the starting position and the ending position as the current starting position and the current ending position. In this case, the swing mechanism can directly swing between the current starting position and the current ending position. Similarly, the air outlet apparatus also enters the customized air outlet angle setting state. When the swing mechanism swings between the current starting position and the current ending position, the user can sequentially select two mutually spaced positions as the new starting position and the new ending position to change the swing range of the swing mechanism and allow the air outlet apparatus to modify the customized air outlet range for air outlet operation. Therefore, after receiving the air outlet angle customization instruction from the user, the air outlet apparatus can control the swing mechanism to directly swing within the historical swing range, making the operation more convenient and thus enhancing the user experience.

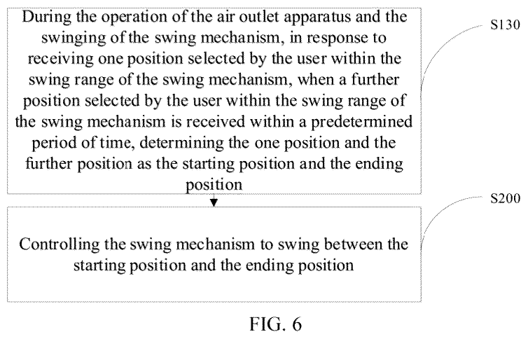

In addition, as illustrated in FIG. 6, in a sixth embodiment of the present disclosure, the operation at block S100 includes operations at blocks below.

At block S130, during the operation of the air outlet apparatus and the swinging of the swing mechanism, in response to receiving one position selected by the user within the swing range of the swing mechanism, when a further position selected by the user within the swing range of the swing mechanism is received within a predetermined period of time, the one position and the further position are determined as the starting position and the ending position.

As the air outlet apparatus receives the air outlet angle customization instruction, during the swinging of the swing mechanism, when the swing mechanism swings to the one position within the swing range, the user selects the one position and the air outlet apparatus determines the one position as the starting position. The swing mechanism continues to swing within the swing range. When the swing mechanism swings to the further position within the swing range and is within the predetermined period of time, the user selects the further position and the air outlet apparatus determines the further position as the ending position. In this case, a range between the starting position and the ending position is a new swing range of the swing mechanism. It should be understood that the user needs to select the starting position and the ending position within the predetermined period of time to complete the customized air outlet angle setting for the air outlet apparatus. When the user does not complete selection of the starting position and the ending position within the predetermined period of time, the air outlet apparatus may exit the customized air outlet angle setting state, and the swing mechanism may continue to swing within the current swing range. In this way, accidental operations by the user can be avoided, such as issuing the air outlet angle customization instruction, which may otherwise change the swing range of the swing mechanism and thus change the customized air outlet angle of the air outlet apparatus.

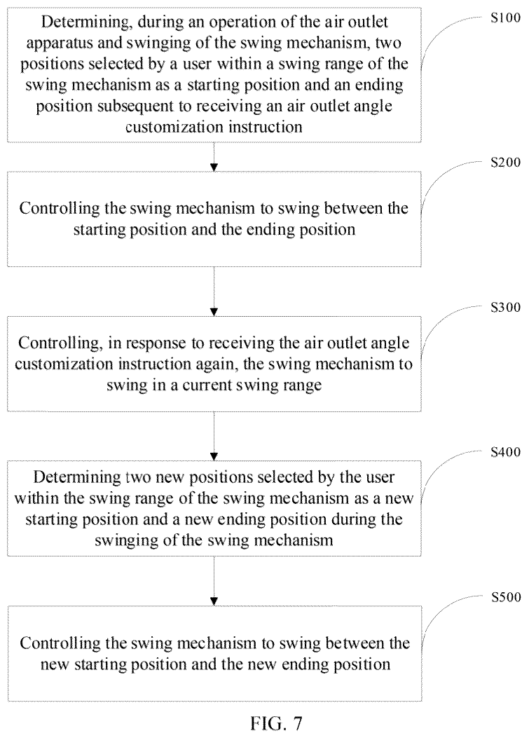

Further, as illustrated in FIG. 7, in a seventh embodiment of the present disclosure, the control method further includes, subsequent to the operation at block S200, operations at blocks below.

At block S300, in response to receiving the air outlet angle customization instruction again, the swing mechanism is controlled to swing in a current swing range.

When the swing mechanism swings between the starting position and the ending position, if the user re-issues the air outlet angle customization instruction, the air outlet apparatus re-enters the customized air outlet angle setting state after receiving the air outlet angle customization instruction again. In this case, the swing mechanism continues to swing between the starting position and the ending position.

At block S400, two new positions selected by the user within the swing range of the swing mechanism are determined as a new starting position and a new ending position during the swinging of the swing mechanism.

During the swinging of the swing mechanism within the current swing range, the user can successively select two mutually spaced new positions within the current swing range. At least one of the two mutually spaced new positions differs from the current starting position and the current ending position. In this case, the two mutually spaced new positions are determined as the new starting position and the new ending position.

At block S500, the swing mechanism is controlled to swing between the new starting position and the new ending position.

It should be understood that the range between the new starting position and the new ending position is the new swing range of the swing mechanism. After the new swing range of the swing mechanism is determined, the current swing range of the swing mechanism is adjusted to the new swing range.

When the user needs to further refine the swing range of the swing mechanism within the current swing range of the swing mechanism, the swing mechanism can reissue the air outlet angle customization instruction to cause the air outlet apparatus to enter the customized air outlet angle setting state. In this case, the swing mechanism can directly swing between the current starting position and the current ending position. In this process, the user can sequentially select two mutually spaced new positions between the current starting position and the current ending position as the new starting position and the new ending position to allow for further refinement of the swing range of the swing mechanism, enabling the air outlet apparatus to more precisely customize the air outlet range for the air outlet operation. In this way, the user can further select a new swing range within the current swing range without removing a current customized air outlet range, which simplifies the operation and further enhances the user experience.

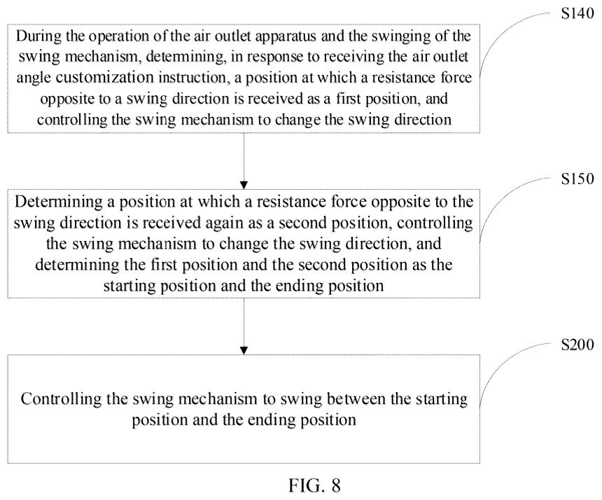

In addition, as illustrated in FIG. 8, in an eighth embodiment of the present disclosure, the operation at block S100 includes operations at blocks below.

At block S140, during the operation of the air outlet apparatus and the swinging of the swing mechanism, in response to receiving the air outlet angle customization instruction, a position at which a resistance force opposite to a swing direction is received is determined as a first position, and the swing mechanism is controlled to change the swing direction.

It should be understood that when the swing mechanism swings in a first direction, if the swing mechanism is subjected to a resistance force opposite to the first direction and having a predetermined magnitude to prevent the swing mechanism from continuing to swing in the first direction, the swing mechanism is controlled to change the swing direction to swing in a second direction opposite to the first direction. The resistance force is regarded as a first selection by the user, and a position at which the resistance force is applied is regarded as the first position selected by the user.

At block S150, a position at which a resistance force opposite to the swing direction is received again is determined as a second position, the swing mechanism is controlled to change the swing direction, and the first position and the second position are determined as the starting position and the ending position.

It should be understood that when the swing mechanism swings in the second direction, if the swing mechanism is subjected to the resistance force again, the direction of the resistance force is opposite to the second direction and has a predetermined magnitude to prevent the swing mechanism from continuing to swing in the second direction, then the swing mechanism is controlled to change the swing direction again and swing again in the first direction, and the resistance force is determined as a second selection by the user, and thus a position at which the resistance force is applied is determined as the second position selected by the user. The first position and the second position are the starting position and the ending position, respectively.

In the above embodiments, position selection is realized by applying an external force to the swing mechanism to prevent the swing mechanism from continuing to swing in the current direction. When the swing mechanism swings to the starting position to be selected by the user during the swing of the swing mechanism, an external force opposite to the current swing direction is applied to the swing mechanism to prevent the swing mechanism from continuing to swing in the current direction, forcing the swing mechanism to change the swing direction, and thus taking the position as the starting position. Subsequently, when the swing mechanism swings to the ending position to be selected by the user, an external force opposite to the current swing direction is applied to the swing mechanism again to prevent the swing mechanism from continuing to swing in the current direction, forcing the swing mechanism to change the swing direction again, and thus taking the position as the ending position.

It should be noted that, in an embodiment, the air outlet apparatus further includes a resistance sensor. When the swing mechanism is subject to the resistance force opposite to the current swing direction during the swinging of the swing mechanism, the resistance sensor can receive resistance information and transmit a swing direction change signal. After receiving the swing direction change signal, the air outlet apparatus controls the swing mechanism to change the swing direction.

In another embodiment, the air outlet apparatus further includes a current detector. A current of the swing mechanism changes if the swing mechanism is subject to the resistance force opposite to the current swing direction during the swinging of the swing mechanism. The current detector is configured to detect current information of the swing mechanism, transmit the swing direction change signal when the current information exceeds a predetermined current threshold. The air outlet apparatus controls the swing mechanism to change the swing direction after receiving the swing direction change signal.

In addition, in other embodiments, the control method further includes, subsequent to the operation at block S200: subsequent to receiving the air outlet angle customization instruction again, canceling the current starting position and the current ending position.

When the swing mechanism swings between the starting position and the ending position, if the user re-issues the air outlet angle customization instruction, the current starting position and the current ending position are canceled after receiving the air outlet angle customization instruction again. The swing mechanism no longer swings between the current starting position and the current ending position.

The air outlet apparatus re-enters the customized air outlet angle setting state.

The swing mechanism is controlled to swing within the maximum allowable range.

After the current starting position and the current ending position are canceled, restrictions of the swing range of the swing mechanism are canceled. That is, the maximum allowable swing range of the swing mechanism is set as the current swing range of the swing mechanism to allow the swing mechanism to swing within the maximum allowable range.

Two positions selected by the user within the maximum allowable range of the swing mechanism are determined as a further starting position and another ending position during the swinging of the swing mechanism.

During the swinging of the swing mechanism within the maximum allowable range, the user can successively select two mutually spaced new positions within the maximum allowable range. In this case, the two mutually spaced new positions are determined as the further starting position and the further ending position.

The swing mechanism is controlled to swing between the further starting position and the further ending position.

It should be understood that a range between the further starting position and the further ending position is a re-selected swing range of the swing mechanism. After the re-selected swing range of the swing mechanism is determined, the current swing range of the swing mechanism is adjusted to the re-selected swing range.

In the above embodiments, the user needs to further select two positions within the current swing range to further refine the customized air outlet angle. However, there is also a scenario where the user needs to select two positions beyond the current swing range to change the customized air outlet angle. Therefore, in this embodiment, a control method for such a scenario is provided. Since the user needs to select two positions beyond the current swing range, if the swing range continues to swing within the current swing range, the swing range is unable to swing a position to be selected by the user. Consequently, when the user sends the air outlet angle customization instruction to the air outlet apparatus, the current starting position and the ending position are canceled as the air outlet apparatus receives this instruction. Restrictions on the swing range of the swing range are removed, allowing the swing mechanism to swing within the maximum allowable range. In this case, the air outlet apparatus also enters the customized air outlet angle setting state. During the swinging of the swing mechanism within the maximum allowable range, the user can sequentially select another two mutually spaced positions to be determined as the another starting position and the further ending position. Therefore, the swing range of the swing range can be changed, enabling the air outlet apparatus to perform the air outlet operation within a newly defined customized air outlet range. Such a setting enables the user to select the further starting position and the further ending position beyond the current swing range, sufficiently satisfying needs of the user and preventing the user from being unable to select the desired customized air outlet range.

An air outlet apparatus is further provided according to the present disclosure. The air outlet apparatus includes a body, an operation device, and a control device. The body includes a blower and a swing mechanism. The swing mechanism is configured to adjust an air outlet direction of the blower. The operation device is arranged at the body. The operation device is configured to receive an air outlet angle customization instruction. The control device is electrically connected to the swing mechanism and the operation device. To satisfy implementation of the above control method for the air outlet apparatus, as illustrated in FIG. 7, the control device includes a processor 1001 (such as a CPU), a communication bus 1002, a user interface 1003, an information interface 1004, and a memory 1005. The communication bus 1002 is configured to realize connection communication between these components. The user interface 1003 may include a display screen and an input unit. An optional user interface 1003 may further include a standard wired interface or a wireless interface. The information interface 1004 may optionally include the standard wired interface or the wireless interface. The memory 1005 may be a high-speed Random Access Memory (RAM), or may be a non-volatile memory such as magnetic disk storage. The memory 1005 may optionally be a storage device independent of the aforementioned processor 1001.

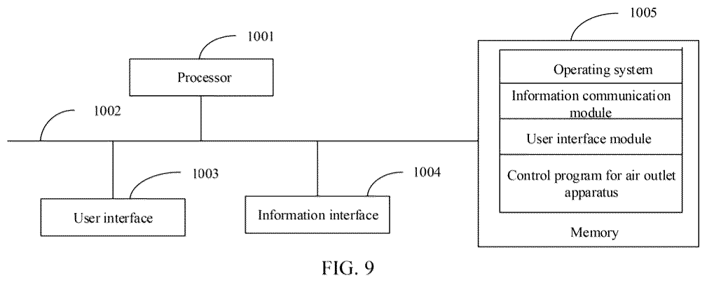

Those skilled in the art can understand that a structure of the control device shown in FIG. 9 does not limit the control device, which may include more or fewer components than those shown in the figures, combine certain components, or have different arrangements of the components.

As illustrated in FIG. 9, the memory 1005 that is a computer storage medium may include an operating system, a network communication module, a user interface module, and a control program for the air outlet apparatus.

In the control device illustrated in FIG. 9, the control program for the air outlet apparatus stored in the memory 1005 is invoked by the processor 1001, and the control method for the air outlet apparatus is executed.

It should be understood that, in an embodiment, the air outlet apparatus further includes a position detection device. The position detection device is arranged corresponding to the swing mechanism to detect and obtain position information of the swing mechanism.

In another exemplary embodiment of the present disclosure, the air outlet apparatus includes a fan, an air conditioner, or a heater. The control method for the air outlet apparatus according to the present disclosure is applicable to the air outlet apparatus that requires adjustment of the air outlet direction.

Although some embodiments of the present disclosure are described above, the scope of the present disclosure is not limited to the embodiments. Under the concept of the present disclosure, any equivalent structure transformation made using the contents of the specification and the accompanying drawings of the present disclosure, or any direct or indirect application of the contents of the specification and the accompanying drawings of the present disclosure in other related fields, shall fall within the scope of the present disclosure.

What is claimed is:

1. A control method comprising:
determining, in response to receiving an air outlet angle customization instruction, two positions selected by a user within a swing range of a swing mechanism of an air outlet apparatus as a starting position and an ending position; and
controlling the swing mechanism to swing between the starting position and the ending position.

2. The control method according to claim 1, wherein determining, in response to receiving the air outlet angle customization instruction, the two positions as the starting position and the ending position includes:
controlling, in response to receiving the air outlet angle customization instruction when the air outlet apparatus is operating and the swing mechanism is in a stopped state, the swing mechanism to operate; and
determining, during swinging of the swing mechanism, the two positions selected by the user within the swing range of the swing mechanism as the starting position and the ending position.

3. The control method according to claim 2, wherein controlling the swing mechanism to operate includes:
controlling the swing mechanism to swing within a maximum allowable range.

4. The control method according to claim 2, wherein controlling the swing mechanism to operate includes:
controlling the swing mechanism to swing within a predetermined swing range that is symmetrical with respect to a center of a maximum allowable swing range of the swing mechanism.

5. The control method according to claim 2, wherein controlling the swing mechanism to operate includes:
obtaining a historical swing range corresponding to the air outlet angle customization instruction; and
controlling the swing mechanism to swing within the historical swing range.

6. The control method according to claim 1, wherein determining, in response to receiving the air outlet angle customization instruction, the two positions as the starting position and the ending position includes:
in response to receiving a first position selected by the user within the swing range and receiving a second position selected by the user within the swing range within a predetermined period of time after receiving the first position, determining the first position and the second position as the starting position and the ending position.

7. The control method according to claim 1, further comprising, after controlling the swing mechanism to swing between the starting position and the ending position:
controlling, in response to receiving the air outlet angle customization instruction again, the swing mechanism to swing in a current swing range;
determining, while the swing mechanism is swinging, two new positions selected by the user within the swing range as a new starting position and a new ending position; and
controlling the swing mechanism to swing between the new starting position and the new ending position.

8. The control method according to claim 1, wherein determining the two positions as the starting position and the ending position includes:
in response to receiving the air outlet angle customization instruction, determining a first position at which a first resistance force opposite to a swing direction and controlling the swing mechanism to change the swing direction;
determining a second position at which a second resistance force opposite to the swing direction, and controlling the swing mechanism to change the swing direction again; and
determining the first position and the second position as the starting position and the ending position.

9. An air outlet apparatus comprising:
a body including a blower and a swing mechanism configured to control an air outlet direction of the blower;
an operation device arranged at the body and configured to receive an air outlet angle customization instruction; and
a control device electrically connected to the swing mechanism and the operation device, the control device including:
a memory storing a control program; and
a processor configured to execute the control program to:
determine, in response to receiving the air outlet angle customization instruction, two positions selected by a user within a swing range of the swing mechanism as a starting position and an ending position; and
control the swing mechanism to swing between the starting position and the ending position.

10. The air outlet apparatus according to claim 9, wherein the processor is further configured to execute the control program to, when determining, in response to receiving the air outlet angle customization instruction, the two positions as the starting position and the ending position:
control, in response to receiving the air outlet angle customization instruction when the air outlet apparatus is operating and the swing mechanism is in a stopped state, the swing mechanism to operate; and
determine, during swinging of the swing mechanism, the two positions selected by the user within the swing range of the swing mechanism as the starting position and the ending position.

11. The air outlet apparatus according to claim 10, wherein the processor is further configured to execute the control program to, when controlling the swing mechanism to operate:
control the swing mechanism to swing within a maximum allowable range.

12. The air outlet apparatus according to claim 10, wherein the processor is further configured to execute the control program to, when controlling the swing mechanism to operate:
control the swing mechanism to swing within a predetermined swing range that is symmetrical with respect to a center of a maximum allowable swing range of the swing mechanism.

13. The air outlet apparatus according to claim 10, wherein the processor is further configured to execute the control program to, when controlling the swing mechanism to operate:
obtain a historical swing range corresponding to the air outlet angle customization instruction; and
control the swing mechanism to swing within the historical swing range.

14. The air outlet apparatus according to claim 9, wherein the processor is further configured to execute the control program to, when determining, in response to receiving the air outlet angle customization instruction, the two positions as the starting position and the ending position:
in response to receiving a first position selected by the user within the swing range and receiving a second position selected by the user within the swing range within a predetermined period of time after receiving the first position, determine the first position and the second position as the starting position and the ending position.

15. The air outlet apparatus according to claim 9, wherein the processor is further configured to execute the control program to, after controlling the swing mechanism to swing between the starting position and the ending position:
control, in response to receiving the air outlet angle customization instruction again, the swing mechanism to swing in a current swing range;
determine, while the swing mechanism is swinging, two new positions selected by the user within the swing range as a new starting position and a new ending position; and
control the swing mechanism to swing between the new starting position and the new ending position.

16. The air outlet apparatus according to claim 9, wherein the processor is further configured to execute the control program to, when determining the two positions as the starting position and the ending position:
in response to receiving the air outlet angle customization instruction, determine a first position at which a first resistance force opposite to a swing direction and controlling the swing mechanism to change the swing direction;
determine a second position at which a second resistance force opposite to the swing direction, and controlling the swing mechanism to change the swing direction again; and
determine the first position and the second position as the starting position and the ending position.

17. The air outlet apparatus according to claim 9, wherein the air outlet apparatus includes a fan, an air conditioner, or a heater.
